(19) United States
(12) Patent Application Publication
(10) Pub. No.: US 2026/0158505 A1
(43) Pub. Date: Jun. 11, 2026

(54) SPRAY APPLICATION VALVE, SPRAY APPLICATION SYSTEM, AND METHODS OF USE THEREOF

(71) Applicant: BMIC LLC, Dallas, TX (US)

(72) Inventors: Norman Chin, Somerville, NJ (US); David Burnett, Arvada, CO (US)

(21) Appl. No.: 19/410,087

(22) Filed: Dec. 5, 2025

Related U.S. Application Data
(60) Provisional application No. 63/728,791, filed on Dec. 6, 2024.

(51) Int. Cl. B05B 1/12; B05B 1/30; B05B 12/00

(52) U.S. Cl. CPC B05B 1/12; B05B 1/3026; B05B 12/002

(57) ABSTRACT

This invention, in embodiments, relates to a method that includes obtaining a spray application system that is configured to apply a fluid material to a surface. The spray application system includes (i) a spray device that is configured to receive the fluid material and to spray the fluid material onto the surface, and (ii) a spray valve that is in fluid communication with the spray device and is configured to be rotated to provide a different spray pattern of the fluid material onto the surface. The method further includes spraying the fluid material onto the surface with a first spray pattern of the spray valve, rotating the spray valve to provide a second spray pattern, and spraying the fluid material onto the surface with the second spray pattern of the spray valve. This invention, in embodiments, further relates to a spray application system and a spray valve.

This application claims the priority of U.S. provisional application Ser. No. U.S. 63/728,791 entitled “Spray Application Valve, Spray Application System, and Methods of Use Thereof” filed Dec. 6, 2024, which is incorporated herein by reference in its entirety for all purposes.

### FIELD OF THE INVENTION

This invention relates to a spray application valve, a spray application system, and methods of using the valve and/or system. A spray application valve and system are provided that allow for a user to easily change a spray pattern for applying, e.g., an adhesive by rotating the valve to a different position.

### BACKGROUND OF THE INVENTION

Typically, spray applicators and/or spray guns use various methods to apply and/or to dispense different patterns of adhesive onto a roof surface. These methods generally involve using different types of spray tips that are placed on and/or removed from the spray applicator or spray gun, as well as specific movements of the operator's hand (e.g., left to right/up and down). There is thus a need for a spray application system that eliminates the different types of spray tips and/or the operator's hand movements in order to apply adhesive in various spray patterns more simply and consistently.

### SUMMARY OF THE INVENTION

One embodiment of this invention pertains to a method comprising obtaining a spray application system that is configured to apply a fluid material to a surface, the spray application system comprising (i) a spray device that is configured to receive the fluid material and to spray the fluid material onto the surface, and (ii) a spray valve that is in fluid communication with the spray device and is configured to be rotated to provide a different spray pattern of the fluid material onto the surface, supplying the fluid material to the spray device, spraying the fluid material onto the surface with a first spray pattern of the spray valve using the spray device of the spray application system, rotating the spray valve to provide a second spray pattern, and spraying the fluid material onto the surface with the second spray pattern of the spray valve using the spray device of the spray application system.

In one embodiment, the spray application system further comprises a mixing tube in which the spray valve is provided, wherein the mixing tube is in fluid communication with the spray device. In another embodiment, the mixing tube further includes an auger configured to provide the fluid material to the spray valve. In one embodiment, the mixing tube includes (i) an inlet through which the fluid material is received from the spray device, and (ii) an outlet through which the fluid material is sprayed onto the surface. In another embodiment, the spray valve is positioned within the outlet of the mixing tube.

In one embodiment, the spray valve includes a knob configured to allow for rotating the spray valve in one of a clockwise direction or a counter-clockwise direction.

In one embodiment, the spray valve comprises a ball member.

In one embodiment, the spray valve includes a first surface having a single opening (e.g., circular opening) that extends through the spray valve from the first surface to an opposing second surface of the spray valve. In one embodiment, the spray valve includes a third surface having a plurality of openings (e.g., circular openings) that extends through the spray valve from the third surface to an opposing fourth surface of the spray valve.

In one embodiment, the first and second surfaces of the spray valve are concave.

In one embodiment, the third and fourth surfaces of the spray valve are convex.

In one embodiment, the first and second surfaces of the spray valve are perpendicular to the third and fourth surfaces of the spray valve.

In one embodiment, rotating a knob of the spray valve in one of a clockwise or a counter-clockwise direction rotates the spray valve from having (i) the first and second surfaces of the spray valve being in fluid communication with the spray device to (ii) the third and fourth surfaces of the spray valve being in fluid communication with the spray device. In one embodiment, rotating a knob of the spray valve in one of a clockwise or a counter-clockwise direction rotates the spray valve from having (i) the third and fourth surfaces of the spray valve being in fluid communication with the spray device to (ii) the first and second surfaces of the spray valve being in fluid communication with the spray device.

In one embodiment, the first spray pattern is at least one of a bead pattern or a splatter pattern.

In one embodiment, the second spray pattern is at least one of a bead pattern or a splatter pattern.

In one embodiment, the first spray pattern is a bead pattern and the second spray pattern is a splatter pattern. In one embodiment, the first spray pattern is a splatter pattern and the second spray pattern is a bead pattern.

In one embodiment, the bead pattern comprises at least one of a 4 inch bead diameter, a 6 inch bead diameter, a 8 inch bead diameter, or a 12 inch bead diameter.

In one embodiment, the first spray pattern is configured to spray the fluid material onto the surface in a single stream. In one embodiment, the first spray pattern is configured to spray the fluid material onto the surface in multiple streams.

In one embodiment, the second spray pattern is configured to spray the fluid material onto the surface in a single stream. In one embodiment, the second spray pattern is configured to spray the fluid material onto the surface in multiple streams.

In one embodiment, the fluid material comprises (i) an adhesive solution, (ii) a coating, or (iii) a combination of (i) or (ii). In an embodiment, the adhesive solution comprises a low rise foam.

In one embodiment, the surface is a roofing surface.

In one embodiment, the spray device is a spray gun.

In one embodiment, the spray application system is hand-held and portable.

Another embodiment of this invention pertains to a spray application system comprising (i) a spray device that is configured to receive a fluid material and to spray the fluid material onto a surface, and (ii) a spray valve that is in fluid communication with the spray device and is configured to be rotated to provide a different spray pattern of the fluid material onto the surface.

In one embodiment, the spray valve is configured to provide (i) a first spray pattern of the fluid material onto the surface and (ii) a second spray pattern of the fluid material onto the surface.

In one embodiment, the spray application system further comprises a mixing tube in which the spray valve is provided, wherein the mixing tube is in fluid communication with the spray device. In another embodiment, the mixing tube further includes an auger configured to provide the fluid material to the spray valve. In one embodiment, the mixing tube includes (i) an inlet through which the fluid material is received from the spray device, and (ii) an outlet through which the fluid material is sprayed onto the surface. In another embodiment, the spray valve is positioned within the outlet of the mixing tube.

In one embodiment, the spray valve includes a knob configured to allow for rotating the spray valve in one of a clockwise direction or a counter-clockwise direction.

In one embodiment, the spray valve comprises a ball member.

In one embodiment, the spray valve includes a first surface having a single opening (e.g., circular opening) that extends through the spray valve from the first surface to an opposing second surface of the spray valve. In one embodiment, the spray valve includes a third surface having a plurality of openings (e.g., circular openings) that extends through the spray valve from the third surface to an opposing fourth surface of the spray valve.

In one embodiment, the first and second surfaces of the spray valve are concave.

In one embodiment, the third and fourth surfaces of the spray valve are convex.

In one embodiment, the first and second surfaces of the spray valve are perpendicular to the third and fourth surfaces of the spray valve.

In one embodiment, rotating a knob of the spray valve in one of a clockwise or a counter-clockwise direction rotates the spray valve from having (i) the first and second surfaces of the spray valve being in fluid communication with the spray device to (ii) the third and fourth surfaces of the spray valve being in fluid communication with the spray device. In one embodiment, rotating a knob of the spray valve in one of a clockwise or a counter-clockwise direction rotates the spray valve from having (i) the third and fourth surfaces of the spray valve being in fluid communication with the spray device to (ii) the first and second surfaces of the spray valve being in fluid communication with the spray device.

In one embodiment, the first spray pattern is at least one of a bead pattern or a splatter pattern.

In one embodiment, the second spray pattern is at least one of a bead pattern or a splatter pattern.

In one embodiment, the first spray pattern is a bead pattern and the second spray pattern is a splatter pattern. In one embodiment, the first spray pattern is a splatter pattern and the second spray pattern is a bead pattern.

In one embodiment, the bead pattern comprises at least one of a 4 inch bead diameter, a 6 inch bead diameter, a 8 inch bead diameter, or a 12 inch bead diameter.

In one embodiment, the first spray pattern is configured to spray the fluid material onto the surface in a single stream. In one embodiment, the first spray pattern is configured to spray the fluid material onto the surface in multiple streams.

In one embodiment, the second spray pattern is configured to spray the fluid material onto the surface in a single stream. In one embodiment, the second spray pattern is configured to spray the fluid material onto the surface in multiple streams.

In one embodiment, the fluid material comprises (i) an adhesive solution, (ii) a coating, or (iii) a combination of (i) or (ii). In an embodiment, the adhesive solution comprises a low rise foam.

In one embodiment, the surface is a roofing surface.

In one embodiment, the spray device is a spray gun.

In one embodiment, the spray application system is hand-held and portable.

Yet another embodiment of this invention pertains to a spray valve that is configured to be in fluid communication with a spray device configured to receive a fluid material and to spray the fluid material onto a surface, wherein the spray valve is configured to be rotated to provide a different spray pattern of the fluid material onto the surface.

In one embodiment, the spray valve is configured to provide (i) a first spray pattern of the fluid material onto the surface and (ii) a second spray pattern of the spray valve of the fluid material onto the surface.

In one embodiment, the spray valve is configured to be provided within a mixing tube that is configured to be in fluid communication with the spray device. In another embodiment, the mixing tube further includes an auger configured to provide the fluid material to the spray valve. In one embodiment, the mixing tube includes (i) an inlet through which the fluid material is received from the spray device, and (ii) an outlet through which the fluid material is sprayed onto the surface. In another embodiment, the spray valve is positioned within the outlet of the mixing tube.

In one embodiment, the spray valve includes a knob configured to allow for rotating the spray valve in one of a clockwise direction or a counter-clockwise direction.

In one embodiment, the spray valve comprises a ball member.

In one embodiment, the spray valve includes a first surface having a single opening (e.g., circular opening) that extends through the spray valve from the first surface to an opposing second surface of the spray valve. In one embodiment, the spray valve includes a third surface having a plurality of openings (e.g., circular openings) that extends through the spray valve from the third surface to an opposing fourth surface of the spray valve.

In one embodiment, the first and second surfaces of the spray valve are concave.

In one embodiment, the third and fourth surfaces of the spray valve are convex.

In one embodiment, the first and second surfaces of the spray valve are perpendicular to the third and fourth surfaces of the spray valve.

In one embodiment, rotating a knob of the spray valve in one of a clockwise or a counter-clockwise direction rotates the spray valve from having (i) the first and second surfaces of the spray valve being in fluid communication with the spray device to (ii) the third and fourth surfaces of the spray valve being in fluid communication with the spray device. In one embodiment, rotating a knob of the spray valve in one of a clockwise or a counter-clockwise direction rotates the spray valve from having (i) the third and fourth surfaces of the spray valve being in fluid communication with the spray device to (ii) the first and second surfaces of the spray valve being in fluid communication with the spray device.

In one embodiment, the first spray pattern is at least one of a bead pattern or a splatter pattern.

In one embodiment, the second spray pattern is at least one of a bead pattern or a splatter pattern.

In one embodiment, the first spray pattern is a bead pattern and the second spray pattern is a splatter pattern. In one embodiment, the first spray pattern is a splatter pattern and the second spray pattern is a bead pattern.

In one embodiment, the bead pattern comprises at least one of a 4 inch bead diameter, a 6 inch bead diameter, a 8 inch bead diameter, or a 12 inch bead diameter.

In one embodiment, the first spray pattern is configured to spray the fluid material onto the surface in a single stream. In one embodiment, the first spray pattern is configured to spray the fluid material onto the surface in multiple streams.

In one embodiment, the second spray pattern is configured to spray the fluid material onto the surface in a single stream. In one embodiment, the second spray pattern is configured to spray the fluid material onto the surface in multiple streams.

In one embodiment, the fluid material comprises (i) an adhesive solution, (ii) a coating, or (iii) a combination of (i) or (ii). In an embodiment, the adhesive solution comprises a low rise foam.

In one embodiment, the surface is a roofing surface.

In one embodiment, the spray device is a spray gun.

### BRIEF DESCRIPTION OF THE FIGURES

For a more complete understanding of the invention and the advantages thereof, reference is made to the following descriptions, taken in conjunction with the accompanying figures, in which:

FIG. 1A is a photograph of a fluid material being applied to a surface in a bead pattern according to an embodiment of the invention.

FIG. 1B is a photograph of a fluid material being applied to a surface in a splatter pattern according to an embodiment of the invention.

FIG. 2A is an illustration of a spray valve according to an embodiment of the invention.

FIG. 2B is an illustration of a first surface of the spray valve of FIG. 2A having a single opening according to an embodiment of the invention.

FIG. 2C is an illustration of another surface of the spray valve of FIG. 2A having a plurality of openings according to an embodiment of the invention.

FIG. 3A is an illustration of a first surface of a spray valve having a single opening according to an embodiment of the invention.

FIG. 3B is an illustration of the spray valve of FIG. 3A being positioned within a mixing tube, with the single opening being in fluid communication with a spray device according to an embodiment of the invention.

FIG. 3C is an illustration of another surface of the spray valve of FIG. 3A having a plurality of openings according to an embodiment of the invention.

FIG. 3D is an illustration of the spray valve of FIG. 3C being positioned within a mixing tube, with the plurality of openings being in fluid communication with a spray device according to an embodiment of the invention.

FIG. 4 is an illustration of an exploded view of a mixing tube having a spray valve according to an embodiment of the invention.

FIG. 5A is an illustration of an internal view of the mixing tube of FIG. 4 having a spray valve according to an embodiment of the invention.

FIG. 5B is an illustration of a side view of the mixing tube of FIG. 4 having a spray valve according to an embodiment of the invention.

FIG. 5C is an illustration of a top, isometric, internal view of the mixing tube of FIG. 4 having a spray valve according to an embodiment of the invention.

### DETAILED DESCRIPTION OF THE INVENTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though they may. Furthermore, the phrases “in another embodiment” and “in some other embodiments” as used herein do not necessarily refer to a different embodiment, although they may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, terms such as “comprising,” “including,” and “having” do not limit the scope of a specific claim to the materials or steps recited by the claim.

As used herein, terms such as “consisting of” limit the scope of a specific claim to the materials and steps recited by the claim.

All prior patents, publications, and test methods referenced herein are incorporated by reference in their entireties.

As used herein, the term “roofing surface” includes, but is not limited to, shingles, roofing membranes, including, e.g., waterproofing membranes, underlayment, and tiles.

Generally, current, commercially available fluid spray, such as, e.g., adhesive (e.g., low rise foam), applicators and/or spray guns use three methods to dispense bead and/or splatter spray patterns on roof surfaces. The most common method is to use a simple open circular tip on a spray nozzle to apply the bead pattern and then to move the applicator or operator's hand left to right and/or up and down to apply a splatter pattern, which is generally inconsistent. The second method is to twist the open circular tip from a horizontal to a vertical position. Finally, a third method is to use the open circular tip for the bead pattern, and to place a shower cap tip having a plurality of holes over the circular tip for a splatter pattern. There is thus a need for a spray application system that eliminates the different types of spray tips and/or the operator's hand movements in order to apply adhesive in various spray patterns more simply and consistently. Accordingly, the spray application system of the instant application integrates all of the current methods into one application tip, eliminating the need for a shower cap tip, twisting of a tip, and/or an applicator's hand movements to apply the bead/splatter patterns, with a built-in valve that allows the operator to apply a bead pattern and then, with a turn of the valve, the operator can apply a consistent splatter pattern.

One embodiment of this invention pertains to a method comprising obtaining a spray application system that is configured to apply a fluid material to a surface, the spray application system comprising (i) a spray device that is configured to receive the fluid material and to spray the fluid material onto the surface, and (ii) a spray valve that is in fluid communication with the spray device and is configured to be rotated to provide a different spray pattern of the fluid material onto the surface, supplying the fluid material to the spray device, spraying the fluid material onto the surface with a first spray pattern of the spray valve using the spray device of the spray application system, rotating the spray valve to provide a second spray pattern, and spraying the fluid material onto the surface with the second spray pattern of the spray valve using the spray device of the spray application system.

Another embodiment of this invention pertains to a spray application system comprising (i) a spray device that is configured to receive a fluid material and to spray the fluid material onto a surface, and (ii) a spray valve that is in fluid communication with the spray device and is configured to be rotated to provide a different spray pattern of the fluid material onto the surface.

Yet another embodiment of this invention pertains to a spray valve that is configured to be in fluid communication with a spray device configured to receive a fluid material and to spray the fluid material onto a surface, wherein the spray valve is configured to be rotated to provide a different spray pattern of the fluid material onto the surface.

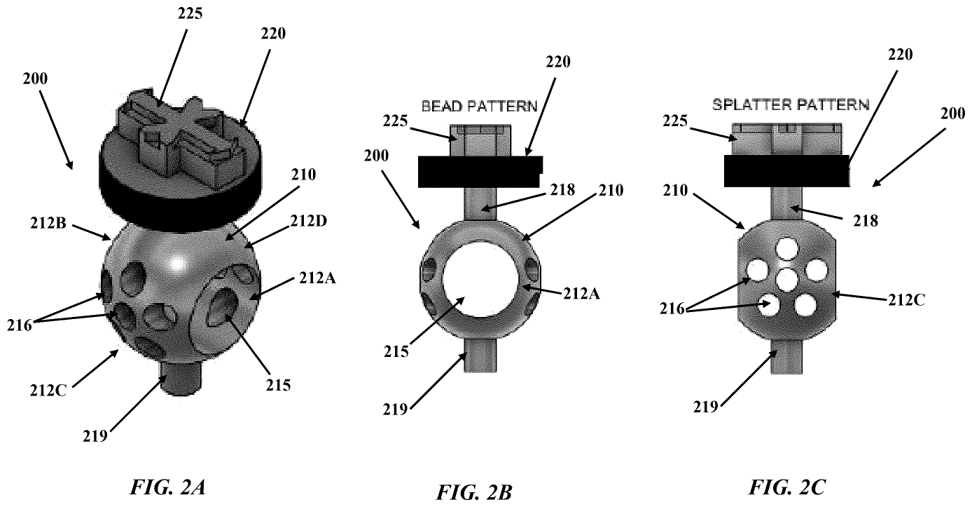

FIGS. 2A-2C illustrate a spray valve 200 for use with a spray application system according to an embodiment of the invention. In this embodiment, the spray valve 200 includes a circular or ball member 210 having a first surface 212A with a single opening 215 (e.g., circular opening) that extends through the ball member 210 of the spray valve 200 from the first surface 212A to an opposing second surface 212B of the spray valve 200. In this embodiment, the ball member 210 of the spray valve 200 further includes a third surface 212C having a plurality of openings 216 (e.g., circular openings) that extends through the ball member 210 of the spray valve 200 from the third surface 212C to an opposing fourth surface 212D of the spray valve 200. Thus, in the embodiment of FIGS. 2A-2C, the first and second surfaces 212A, 212B of the spray valve 200 are perpendicular to the third and fourth surfaces 212C, 212D of the spray valve 200. As also shown in the embodiment of FIG. 2A, the first and second surfaces 212A, 212B of the spray valve 200 are concave, while the third and fourth surfaces 212C, 212D of the spray valve 200 are convex.

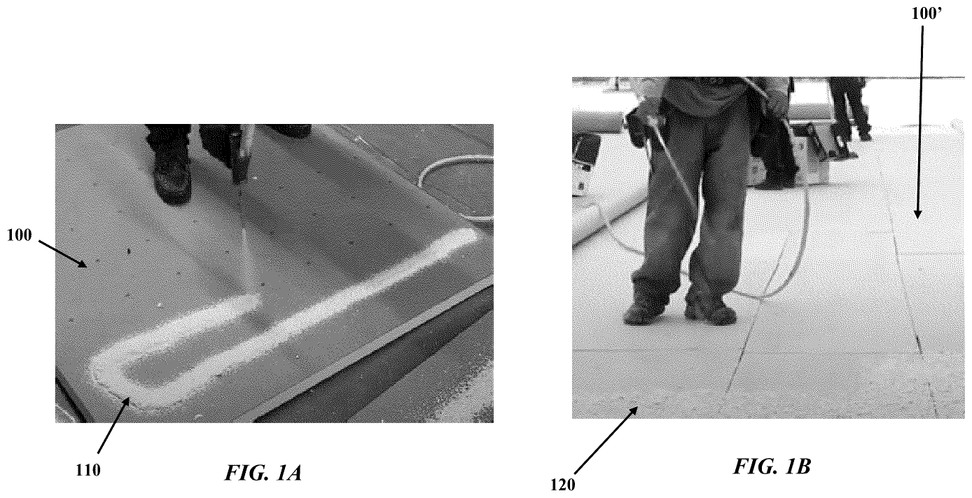

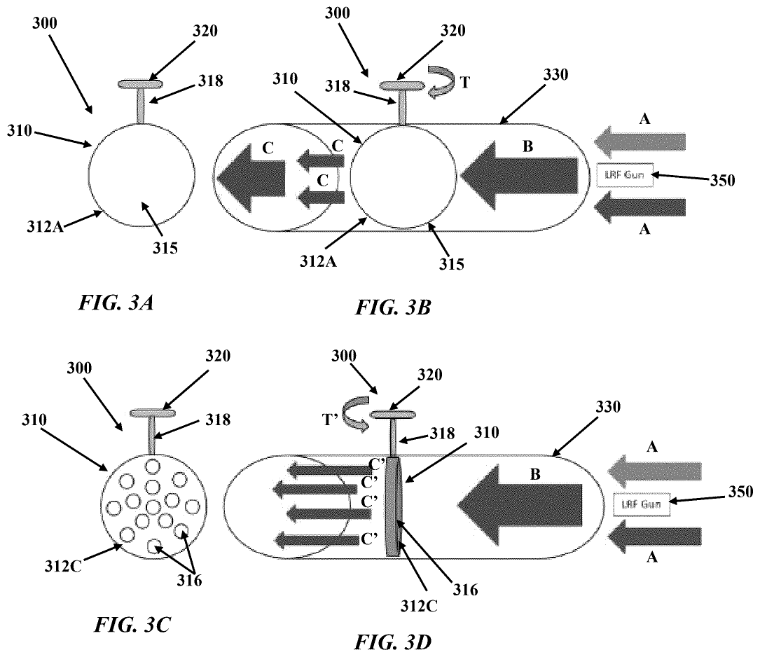

As further shown in the embodiment of FIGS. 2A-2C, the spray valve 200 includes a knob 220 having a gripping member 225, with the knob 220 being connected to the ball member 210 of the spray valve 200 via a rod member 218. The knob 220 is configured to allow for rotating the spray valve 200 in one of a clockwise direction or a counter-clockwise direction via the gripping member 225. According to one embodiment, rotating the knob 220 of the spray valve 200 (via, e.g., the gripping member 225) in one of a clockwise or a counter-clockwise direction rotates the spray valve 200 from having (i) the first and second surfaces 212A, 212B of the spray valve 200 being in fluid communication with a spray device (see, e.g., FIG. 3B, which is described in detail below) to (ii) the third and fourth surfaces 212C, 212D of the spray valve 200 being in fluid communication with a spray device (see, e.g., FIG. 3D, which is described in detail below). In another embodiment, rotating the knob 220 of the spray valve 200 (via, e.g., the gripping member 225) in one of a clockwise or a counter-clockwise direction rotates the spray valve 200 from having (i) the third and fourth surfaces 212C, 212D of the spray valve 200 being in fluid communication with a spray device (see, e.g., FIG. 3D, which is described in detail below) to (ii) the first and second surfaces 212A, 212B of the spray valve 200 being in fluid communication with a spray device (see, e.g., FIG. 3B, which is described in detail below). Thus, according to the embodiment of FIGS. 2A-2C, the spray valve 200 is configured to provide (i) a first spray pattern of a fluid material onto a surface and (ii) a second spray pattern of a fluid material onto a surface, with (i) the first spray pattern being, e.g., a bead pattern (see, e.g., FIG. 1A) in which the first and second surfaces 212A, 212B of the spray valve 200, which include the single opening 215, are in fluid communication with a spray device, and (ii) the second spray pattern being, e.g., a splatter pattern (see, e.g., FIG. 1B) in which the third and fourth surfaces 212C, 212D of the spray valve 200, which include the plurality of openings 216, are in fluid communication with a spray device. (See also, e.g., FIGS. 3A-3D.)

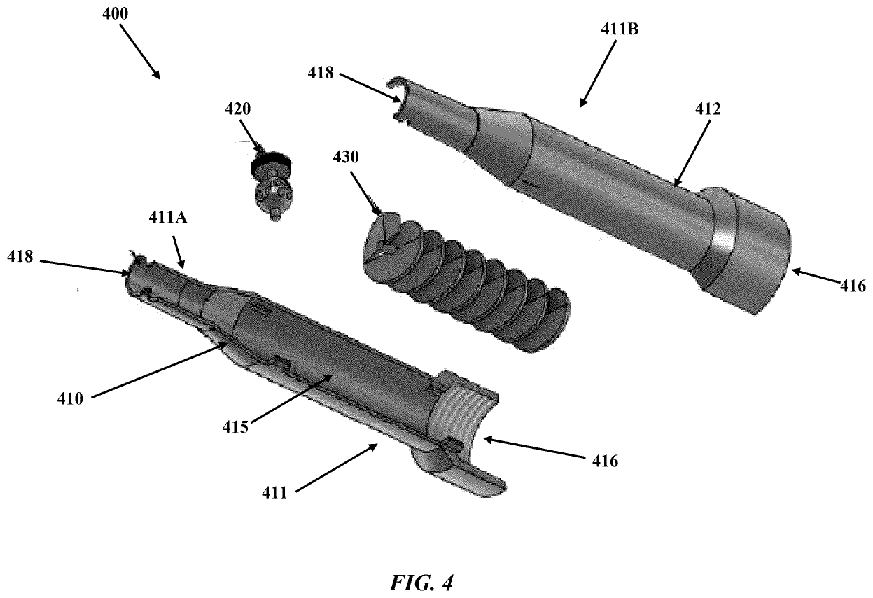

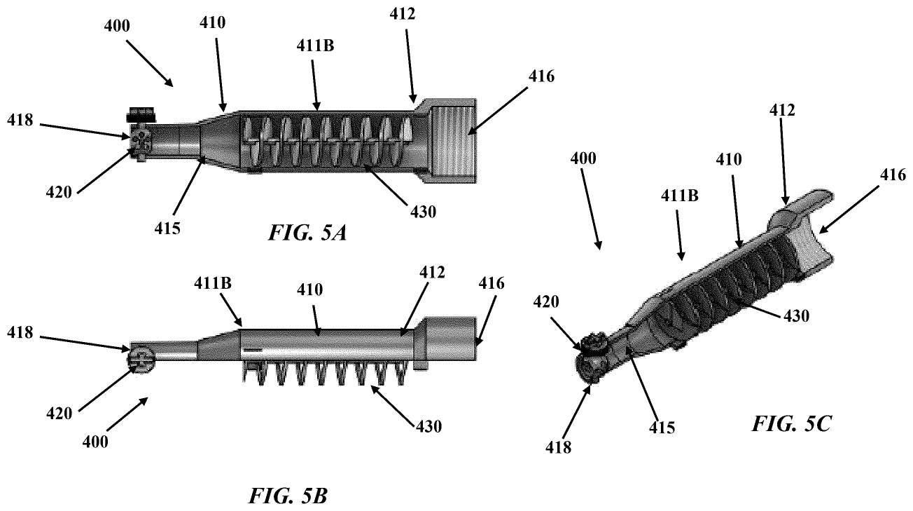

As further shown in the embodiment of FIGS. 2A-2C, the spray valve 200 can also included a lower connection member 219 that allows for inserting the spray valve 200 into a mixing tube as further described below. (See also, e.g., FIGS. 4 and 5A-5C.)

In one embodiment, the spray valve is provided within a mixing tube that is in fluid communication with the spray device. For example, as shown in the embodiment of FIGS. 3A-3D, a spray valve 300 is illustrated, with the spray valve 300 comprising a ball member 310 having a first surface 312A with a single opening 315 (e.g., circular opening) that extends through the ball member 310, such that the spray valve 300 can be positioned within a mixing tube 330 that is placed into fluid communication with a spray device 350 (e.g., a spray gun) through which a fluid material (e.g., adhesive) is provided in a first flow path (labeled as A in FIGS. 3A and 3D). As shown in the embodiment of FIG. 3B, the spray valve 300 is placed within the mixing tube 330, such that the first surface 312A of the ball member 310 having the single opening 315 is placed into fluid communication with the fluid material being provided by the spray device 350. In this regard, the fluid material enters the mixing tube 330 from the spray device 350 as a second flow path (labeled as B in FIGS. 3B and 3D), which thereafter travels through the single opening 315 (e.g., circular opening) of the first surface 312A of the ball member 310 of the spray valve 300. The single opening 315 (e.g., circular opening) of the first surface 312A of the ball member 310 of the spray valve 300 allows for the fluid material to travel in one flow path (B) through the single opening 315 and thereby exit the single opening 315 as a single flow path (or stream) (labeled as C in FIG. 3B), which allows for the fluid material to be applied to a surface as a first spray pattern or a bead pattern, according to this embodiment. (See also, e.g., FIG. 1A, which illustrates an example of a bead pattern 110 of a fluid material being applied onto a surface 100.)

In one embodiment, the bead pattern comprises at least one of a 4 inch bead diameter, a 6 inch bead diameter, a 8 inch bead diameter, or a 12 inch bead diameter.

As shown in the embodiment of FIG. 3C, the ball member 310 of the spray valve 300 of FIG. 3A further includes a third surface 312C having a plurality of openings 316 (e.g., circular openings) that extends through the ball member 310, such that the spray valve 300 can be positioned within a mixing tube 330 that is placed into fluid communication with a spray device 350 (e.g., a spray gun) through which a fluid material (e.g., adhesive) is provided in a first flow path (labeled as A in FIGS. 3A and 3D). As shown in the embodiment of FIG. 3D, the spray valve 300 is placed within the mixing tube 330, such that the third surface 312C of the ball member 310 having the plurality of openings 316 is placed into fluid communication with the fluid material being provided by the spray device 350. In this regard, the fluid material enters the mixing tube 330 from the spray device 350 as a second flow path (labeled as B in FIGS. 3B and 3D), which thereafter travels through the plurality openings 316 (e.g., circular openings) of the third surface 312C of the ball member 310 of the spray valve 300. The plurality of openings 316 (e.g., circular openings) of the third surface 312C of the ball member 310 of the spray valve 300 allows for the fluid material to travel in one flow path (B) through the plurality of openings 316 and thereby exit the plurality of openings 316 as a plurality of flow paths (or streams) (labeled as C′ in FIG. 3D), which allows for the fluid material to be applied to a surface as a second spray pattern or a splatter pattern, according to this embodiment. (See also, e.g., FIG. 1B, which illustrates an example of a splatter pattern 120 of a fluid material being applied onto a surface 100′.)

As further illustrated in the embodiment of FIGS. 3A-3D, once the spray valve 300 is placed within the mixing tube 330, the spray valve 300 can be rotated in a first direction (e.g., a clockwise direction) (labeled as T in FIG. 3B) by gripping a knob 320 of the spray valve 300 that is connected to the ball member 310 via a rod member 318, in order to place, e.g., the first surface 312A of the ball member 310 having the single opening 315 into fluid communication with the fluid material being provided by the spray device 350. Thereafter, the spray valve 300 can be rotated in a second direction (e.g., a counter-clockwise direction) (labeled as T′ in FIG. 3D) by gripping the knob 320 of the spray valve 300 that is connected to the ball member 310 via the rod member 318, in order to place, e.g., the third surface 312C of the ball member 310 having the plurality of openings 316 into fluid communication with the fluid material being provided by the spray device 350.

FIGS. 4 and 5A-5C illustrates a spray application system 400 that is configured to be in fluid communication with (or attached to) a spray device (e.g., a spray gun), which is configured to receive a fluid material according to an embodiment of the invention. According to the embodiment of FIGS. 4 and 5A-5C, the spray application system 400 comprises a mixing tube 410 formed by a housing 411 that includes a first housing side 411A and a second housing side 411B and having an exterior surface 412 and an interior surface 415. The mixing tube 410 (or housing 411) includes (i) an inlet 416 through which a fluid material can be received from a spray device (e.g., a spray gun), and (ii) an outlet 418 through which the fluid material can be sprayed onto a surface. In the embodiment of FIGS. 4 and 5A-5C, a spray valve 420 (such as, e.g., the spray valves described above) is positioned within the outlet 418 of the mixing tube 410. As further shown in FIGS. 4 and 5A-5C, the mixing tube 410 further includes an auger 430 configured to provide a fluid material from the inlet 416 to the spray valve 420 positioned at the outlet 418 of the mixing tube 410.

In one embodiment, the fluid material comprises (i) an adhesive solution, (ii) a coating, or (iii) a combination of (i) or (ii). In an embodiment, the adhesive solution comprises a low rise foam.

In one embodiment, the surface is a roofing surface. According to an embodiment, the roofing surface includes, but is not limited to, shingles, roofing membranes, including, e.g., waterproofing membranes, underlayment, and tiles.

In one embodiment, the spray device is a spray gun.

In one embodiment, the spray application system is hand-held and portable.

According to embodiments described herein, a newly designed spray nozzle (or tip/valve) is provided that will allow for users to go from applying a fluid material (e.g., an adhesive) in various bead patterns (e.g., 4″, 6″, 8″, 12″ beads, on center) to applying the fluid material (e.g., an adhesive) in a splatter pattern by simply turning an integrated knob or valve, which changes the stream outflow from a single stream (bead pattern) (see, e.g., FIG. 1A) to multiple streams (splatter pattern) (see, e.g., FIG. 1B). This integrated valve allows users to switch from a bead pattern to a splatter pattern or vice versa easily. According to embodiments described herein, the spray nozzle or valve of the instant application can prevent the need to change or switch out spray tips or twisting of the tip from a vertical to a horizontal position, which can reduce the downtime during the application of an adhesive, eliminate an operator's need to move their applicator hand from left to right or up and down, which generally creates an inconsistent or sporadic splatter pattern, and/or reduce or eliminate hand/wrist fatigue.

According to embodiments described herein, a newly designed spray nozzle (or tip/valve) is provided that will increase an operator's productivity when applying a fluid material (e.g., an adhesive) to a surface, which can decrease the time needed to install, e.g., roofing materials such as, e.g., ISO/HD boards, cover boards, and/or roofing membranes to a roofing surface.

According to embodiments described herein, a newly designed spray nozzle or integrated spray valve is provided that simplifies the ability to easily switch from a first spray pattern (e.g., a bead pattern) to a second spray pattern (e.g., a splatter pattern), and vice versa, when applying a fluid material (e.g., an adhesive) to a surface, without requiring any additional attachments or requiring a tip to be accurately positioned in the correct position.

Although the invention has been described in certain specific exemplary embodiments, many additional modifications and variations would be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

1. A method comprising:
obtaining a spray application system configured to apply a fluid material to a surface, the spray application system comprising:
(i) a spray device that is configured to receive the fluid material and to spray the fluid material onto the surface; and
(ii) a spray valve that is in fluid communication with the spray device and is configured to be rotated to provide a different spray pattern of the fluid material onto the surface;
supplying the fluid material to the spray device;
spraying the fluid material onto the surface with a first spray pattern of the spray valve using the spray device of the spray application system;
rotating the spray valve to provide a second spray pattern; and
spraying the fluid material onto the surface with the second spray pattern of the spray valve using the spray device of the spray application system.

2. The method according to claim 1, wherein the spray application system further comprises a mixing tube in which the spray valve is provided, wherein the mixing tube is in fluid communication with the spray device.

3. The method according to claim 2, wherein the mixing tube includes (i) an inlet through which the fluid material is received from the spray device, and (ii) an outlet through which the fluid material is sprayed onto the surface.

4. The method according to claim 1, wherein the spray valve includes a knob configured to allow for rotating the spray valve in one of a clockwise direction or a counter-clockwise direction.

5. The method according to claim 1, wherein the spray valve includes a first surface having a single opening that extends through the spray valve from the first surface to an opposing second surface of the spray valve.

6. The method according to claim 5, wherein the spray valve includes a third surface having a plurality of openings that extends through the spray valve from the third surface to an opposing fourth surface of the spray valve.

7. The method according to claim 6, wherein rotating a knob of the spray valve in one of a clockwise or a counter-clockwise direction rotates the spray valve from having (i) the first and second surfaces of the spray valve being in fluid communication with the spray device to (ii) the third and fourth surfaces of the spray valve being in fluid communication with the spray device.

8. The method according to claim 1, wherein the first spray pattern is a bead pattern and the second spray pattern is a splatter pattern.

9. The method according to claim 1, wherein the fluid material comprises (i) an adhesive solution, (ii) a coating, or (iii) a combination of (i) or (ii).

10. The method according to claim 1, wherein the surface is a roofing surface.

11. A spray application system comprising:
(i) a spray device that is configured to receive a fluid material and to spray the fluid material onto a surface; and
(ii) a spray valve that is in fluid communication with the spray device and is configured to be rotated to provide a different spray pattern of the fluid material onto the surface.

12. The spray application system according to claim 11, wherein the spray valve is configured to provide (i) a first spray pattern of the fluid material onto the surface and (ii) a second spray pattern of the fluid material onto the surface.

13. The spray application system according to claim 11, wherein the spray application system further comprises a mixing tube in which the spray valve is provided, wherein the mixing tube is in fluid communication with the spray device.

14. The spray application system according to claim 11, wherein the spray valve includes a knob configured to allow for rotating the spray valve in one of a clockwise direction or a counter-clockwise direction.

15. The spray application system according to claim 11, wherein the spray valve includes (i) a first surface having a single opening that extends through the spray valve from the first surface to an opposing second surface of the spray valve, and (ii) a third surface having a plurality of openings that extends through the spray valve from the third surface to an opposing fourth surface of the spray valve.

16. A spray valve that is configured to be in fluid communication with a spray device configured to receive a fluid material and to spray the fluid material onto a surface, wherein the spray valve is configured to be rotated to provide a different spray pattern of the fluid material onto the surface.

17. The spray valve according to claim 16, wherein the spray valve includes a knob configured to allow for rotating the spray valve in one of a clockwise direction or a counter-clockwise direction.

18. The spray valve according to claim 16, wherein the spray valve comprises a ball member.

19. The spray valve according to claim 16, wherein the spray valve includes (i) a first surface having a single opening that extends through the spray valve from the first surface to an opposing second surface of the spray valve, and (ii) a third surface having a plurality of openings that extends through the spray valve from the third surface to an opposing fourth surface of the spray valve.

20. The spray valve according to claim 19, wherein the first and second surfaces of the spray valve are perpendicular to the third and fourth surfaces of the spray valve.
